(19) United States
(12) Patent Application Publication
(10) Pub. No.: US 2020/0187429 A1
(43) Pub. Date: Jun. 18, 2020

(54) PLANT SUPPORT AND GROWTH DIRECTING APPARATUS AND METHOD OF USE

(71) Applicants: Christopher di Muro, Richmond, VT (US); Lindsey di Muro, Richmond, VT (US)

(72) Inventors: Christopher di Muro, Richmond, VT (US); Lindsey di Muro, Richmond, VT (US)

(21) Appl. No.: 16/793,705

(22) Filed: Feb. 18, 2020

Related U.S. Application Data
(63) Continuation of application No. 15/338,359, filed on Oct. 29, 2016.
(60) Provisional application No. 62/249,005, filed on Oct. 30, 2015.

(51) Int. Cl. A01G 9/12

(52) U.S. Cl. CPC A01G 9/128; A01G 9/124; A01G 9/12

(57) ABSTRACT

This invention is able to enhance growth of plants and increase plant production by increasing exposure to air and light and stressing the plant. The apparatus has at least one post and at least one crown attached thereto. At least one of the crowns has a plurality of spaces sized and configured to receive, stress and support branches of a plant to define user desired growing pattern of the plant. In one configuration, the spaces are interstitial between coils of a coiled member, such as a spring, that is attached to or part of the crown. The crown is surfaced with an abrasive material such as a sand or polymer grit thereby more effectively holding the plant in place and providing a means to abrade or stress the plant to stimulate a growth response which can be controlled over the internet by means of a cellular microcontroller.

### CROSS REFERENCE TO RELATED APPLICATION

This application is a Continuation-In-Part of the Co-Pending patent application U.S. Ser. No. 15/338,359, filed Oct. 29, 2016, which claimed priority from Provisional Patent Application No. 62/249,005 which was filed on Oct. 30, 2015.

### STATEMENT AS TO RIGHTS TO INVENTIONS MADE UNDER FEDERALLY SPONSORED RESEARCH OR DEVELOPMENT

Not applicable.

### REFERENCE TO A SEQUENCE LISTING, A TABLE OR A COMPUTER PROGRAM LISTING APPENDIX SUBMITTED ON A COMPACT DISC

Not Applicable.

### FIELD OF THE INVENTION

This invention relates generally to plant accessories, and more particularly, to supports for plants which may be used for controlling or directing plant growth. This invention also relates to the methods of using the invention to maximize the vitality, growth and in some instances appearance of plants such as in ornamental plants in a wide variety of applications including indoor and outdoor environments and support a plant in a manner that separates plant parts to improve the amount of air and light that is beneficially received by the plant.

### BACKGROUND

According to Genesis 2:15 and 3:23, the cultivation of plants and birth of agriculture appears to have occurred very soon after the dawn of man. Archaeological evidence of mankind's transition from hunter gatherer to agriculturalist or farmer exists all over the globe. For instance the cultivation of taro and yam in Papua New Guinea has been reliably dated back to at least 6950-6440 B.C.E. Dating from the time period of Egyptian cultures and other contemporary ancient cultures when mankind first developed written languages there exists a huge volume of writings containing in some instances very sophisticated agricultural processes that are thousands of years old.

Horticulture, however, is the branch of agriculture that deals with the art, science, technology, and business of growing plants, all of which are generally the subject of our invention. Horticulture includes the cultivation of medicinal plants, fruits, vegetables, nuts, seeds, herbs, sprouts, vegetables, nuts, seeds, mushrooms, algae, flowers, seaweeds and non-food crops such as grass and ornamental trees and plants. It also includes plant conservation, landscape restoration, landscape and garden design, construction, and maintenance, and arboriculture. Horticulture contrasts with the agricultural practices of extensive field farming as well as animal husbandry.

The study and science of horticulture dates back to the time of Cyrus the Great of ancient Medo-Persia circa 537 B.C.E. Advances in the disciplines of biological and chemical sciences, not the least of which being selective breeding, chemical fertilization (chemical nitrogen fixation) and genetic engineering have all led to advances in plant science and agricultural economics upon which the 21^{st} century world depends.

Horticulturists apply their knowledge, skills, and technologies used to grow intensively produced plants for human food and non-food uses and for personal, recreational or social needs. Their work involves plant propagation and cultivation with the aim of improving plant growth, yields, quality, nutritional or medicinal value concentration or potency, and resistance to insects, diseases, and environmental stresses. They work as gardeners, growers, therapists, designers, and technical advisors in the food and non-food sectors of horticulture. Horticulture even refers to the growing of plants in a field or garden.

Horticulturists have found that it is possible to manipulate the growth of plants to conform to a desired growth pattern. Such manipulation techniques that enhance growth are generally known as “training” the plant. In most cases training involves the bending of a portion of a plant in order to control the manner and direction in which the plant grows in a desired manner. It is well known that the yield of any particular plant is directly related to the plant's exposure to a light source, natural or artificial, upon which the plant depends for photosynthesis. Therefore one of the primary objects of training a plant is to maximize light exposure. Some horticulturalists have concluded that such factors as wind direction, wind speed and direction of growth in relation to the rotation of the earth and the magnetic poles of the earth may positively influence the growth of plants. One of the objects of our invention is to permit a user to direct the growth of a plant to take advantage of these beneficial factors.

Many different implements have been used to train plants which include such things as netting, cages, slitted tubes, twist ties, Velcro® straps, pipe cleaners, rubber bands, strings and stakes, etc. These implements are not only cumbersome and difficult to adjust with plant growth they are also quite time consuming to use and as a plant grows it shifts all of the ties, often requiring frequent alterations be made. These implements often interfere with one another which can cause tangling and knotting that may train the plant in an undesired manner.

It is fairly common for plants to become damaged during the course of their growth, however, it is well known that this damage may actually be advantageous, especially if controlled. In many cases horticulturalists often intentionally damage or stress plants in order to stimulate a growth and healing response that will ultimately increase the plant yield and facilitate the training of the plant. One such technique called “super cropping” which typically involves either “high stress” such as “cracking” of a user desired portion of the plant and “low stress” training which is discussed below. In super cropping the plant limbs are twisted (cracked) in order that the fibrous elements within the plant's stem are damaged thereby forcing the plant to respond to the injury and repair the damage initiating a phytohormone hormonal response within the plant thereby creating a stronger plant. Super cropping is done by hand and is difficult to control and often leads to loss of the “cracked” stem and many times result in the killing of the plant. There appears to be no device available that would permit a user to train the growth of a plant's limbs or branches that would: 1) be quick and easy to affix in a user desired position the desired plant stem or branch being trained; 2) be quick and easy to remove and readjust the desired plant stem or branch being trained as the plant grows; 3) permits a user to complete a controlled damage or stress to a plant to stimulate a growth and healing response that minimizes the risk of loss of a plant or plant stem often experienced in super cropping; 4) permits a user to remotely monitor and control plant stress levels; 5) permits a user to remotely monitor and control environmental conditions; 6) utilizes magnetism to direct and stimulate growth; 7) utilizes support structures with a low coefficient of thermal conductivity to minimize heat transfer from a light source to the plant.

As is well known, there are a wide variety of different configurations of plant supports that are beneficially utilized to support a plant as it grows. One common type of plant support is a stake that is driven into the ground, typically relatively near the main stem of the plant, to which the plant is secured with wire, string, rope or other securing members. One concern with using a stake is that the person driving the stake in the ground must be as careful as possible, which is often hard to achieve, not to damage the roots of the plant, especially the taproot. Typically, only one stake is utilized if the only support that is needed is for the main stem. If the plant needs support for its branches or limbs, the user usually attaches one or more lateral support members to the stake or, often more common, has to use multiple stakes in the soil around the main stem. Naturally, the use of multiple stakes increases the likelihood that the roots of the plant will be damaged by one or more of the stakes. Instead of using multiple stakes when support is needed for the branches and limbs of the plant, particularly in an area having multiple plants, users commonly use trellises, netting and the like. One common type of trellis support system comprises a plurality of vertical support members interconnected by a plurality of generally laterally and/or angularly positioned support members that are attached to and often interconnect the vertical support members. The trellis support members are commonly made of wood, metal, plastic, fiberglass and the like. Another type of trellis system uses wire, rope, string or like elongated members configured in an interconnected grid to support the branches, limbs and other plant parts, including often the produce. While the use of multiple stakes, trellises, nets and the like have a number of benefits with regard to better supporting many types of plants, they do have a number of limitations, particularly with other types or varieties of plants. One such limitation is that because of their configuration these types of support systems are difficult to arrange so that they can beneficially train the plant to grow in the manner in which the user believes will benefit the plant and the produce to be produced therefrom. Generally, using multiple stakes does not provide a useful framework for training the branches and limbs to grow in the manner that is desired by the user. Trellis and grid systems usually cut down on the number of stakes that are required to support the plants, and in some configurations can even eliminate the use of stakes, and generally allow the user to better train the plants by moving the wires, ropes, strings or other elongated members as necessary to adjust for plant growth. Unfortunately, depending on the growth rate of the plant and necessary training, this can require the user to frequently move or otherwise adjust the elongated members to obtain the desired training of the plants. With regard to training the plants for improved light into the center of the plant, because the trellis system is usually placed over the plants, a possible unintentional effect of the trellis system is to block sunlight or other light from reaching the interior and lower areas of the plant. With regard to harvesting the produce of the plant, the various elongated members and other components of the trellis system can get in the way of harvesting, causing the harvesting process to be more difficult and to take longer than would otherwise be necessary.

Another limitation to the use of trellises, grids, nets and the like is that the growing area for the plant is generally defined and somewhat limited by the boundaries of such systems. While this is typically not a problem for those plants which are grown in the ground, many users prefer to grow the plants in pots, buckets, planters and like containers (which are collectively referred to as pots) because they can more easily access the plants for trimming, treating and harvesting the plants and to move or rotate the plants as necessary for improved access to light, water or for other purposes. As such, the use of most types of trellises, grids, nets and like support systems can cause unintended, but hard to avoid, difficulties or limitations with growing plants when the plants are grown in pots. As readily appreciated by those skilled in the art of growing plants in pots, the use of such support systems results in loss of some of the benefits of growing plants in pots. As well known in the art, virtually all plants have evolved to grow in particular growth patterns in the wild that optimize the plant's exposure to sunlight as the sun travels in an arc across the sky during the day. However, for a variety of reasons, many people prefer to grow certain plants, particularly those in the Cannabis family, indoors using indoor lights for the necessary light and fans for the airflow. Because indoor growing facilities normally have stationary light sources, the plant's natural growth patterns may not be very efficient for indoor harvesting of these plants. Efforts have been made to provide systems that better optimize light exposure for indoor plant cultivation, such as providing moving lamps, support sticks and the like. However, as well known in the art, growing improvements such as these are generally somewhat expensive and/or tedious to install. Furthermore, as set forth above, many plant supports and common wire plant cages are fixed and, therefore, cannot be adapted for changing growth habits of individual plants.

Relatively recently, the harvesting of plants in the Cannabis family has become much more wide-spread and commercialized. The natural growth pattern of Cannabis plants produces a generally triangular-shaped plant. As generally well known in the art of growing such plants, the optimization of the growth of and production from Cannabis plants typically involves arranging multiple support sticks around a plant to provide support and guidance for the branches and limbs of the plant. Although the process of arranging the support sticks is tedious, labor intensive and often requires a significant amount of time to implement, most users consider such plant supports necessary to “combat” the natural growth pattern of Cannabis plants. The natural triangle shape of Cannabis plants is known to limit the amount of air and light that reaches the interior branches and limbs of the plant, which significantly reduces the amount the plant will produce. Spreading out the limbs and branches of a Cannabis plant is known to benefit the growth of the plant and to increase the amount of plant production.

With respect to plants, and in particular regarding the Cannabis plant (including Cannabis sativa and Cannabis indica), growth and development is dictated by the dominant apical meristem of the plant. The dominant apical meristem is the main shoot or dominant central stem of a plant where plant growth originates. Growth of plants is focused at the apical meristem such that secondary shoots originating from the apical meristem grow less rapidly than the apical meristem does. Traditionally, in the wild, many plants, such as, but not limited to, those within the Cannabis family, have a single dominant apical meristem that creates a Christmas tree-like or triangular growth pattern. This pattern optimizes a plant's ability to absorb light in the wild from the sun's exposure as it arcs across the sky during the course of the day. However, this growth pattern is inefficient when these plants are cultivated indoors and when an overhead stationary light source is used because the stationary light source does not adequately provide light to all parts of the plant, resulting in uneven growth and a waste of light and plant resources. Accordingly, current industry techniques attempt to induce horizontal growth of plants over vertical growth, such that a plant may better utilize light generated at a stationary indoor light source. These techniques include topping, super cropping, and low stress training.

Topping is employed by removing the top of the main shoot, or apical meristem, to transfer apical dominance (i.e., the tendency for the apex to grow more rapidly than the rest of the plant) to the shoots emanating from the two nodes immediately beneath the pruning cut. This process may be repeated at the two new secondary shoots, and so on. Removal of the top of the dominant apical meristem inhibits vertical growth and encourages the plant to grow horizontally into a bush having more secondary shoots, rather than vertically through the apical meristem. This technique allows the traditional Christmas tree-like shape of many plants, such as, but not limited to, those within the Cannabis family, to become more flat at the top and form more of a martini glass-like shape. As a result, this shape allows for more horizontal surface area of the plant, which increases light absorption by the plant from a stationary light source.

There is an optimal level of light intensity to growing indoors (a.k.a. Absorption Horizon™). The distance from a plant to its light source is crucial to the life and development of the female flowers in order to maximize and benefit from its food source (a.k.a. light). If the canopy is too close to the light source, it will burn, wilt, and potentially die. Contrarily, if the canopy is too far away from the light source, development will be hindered and underdeveloped. Premature flowers will result. This condition is what we call the Absorption Horizon™ Another common technique is super cropping (also known as high stress training or pinching). Super cropping involves firmly pinching the apical meristem of the plant so as to damage the apical meristem tissue to cause lower limbs of the plant to grow more rapidly while the pinched tissue heals. By increasing growth at a plant's lower sites, away from where the damage occurred, the plant's growth pattern becomes shorter and more horizontal, resulting in increased light absorption by the plant from a stationary light source.

Low stress training (LST) is an additional method for inducing horizontal plant growth. Here, a user pulls a plant in a downward direction to force more lateral growth of the plant and to increase light exposure to lower branches of the plant from an overhead stationary light source. In particular, LST involves tying down a plant to hold the induced downward position and to force lateral growth of the plant. In addition, LST may be used in conjunction with topping or super cropping (e.g., after implementing the topping or super cropping techniques). However, although LST may be effective for inducing lateral plant growth to increase plant light absorption, it may be a time consuming process in tying down a plant at several locations as the plant grows.

Most plants and crops are trained in certain fashions to have more exposure to the sun thus exposing more sites (flower and/or fruit). This training is directed to produce a higher yield measured in quantity and to simply ripen the fruit or flower. In contrast to most plants the Cannabis flower development is most enhanced when all the upper sites grow together and form a cola, a single large flower, or a central flower cluster. This flower formation of Cannabis is maximized by indoor growing under intense high pressure sodium, metal halide or ceramic bulbs. By utilizing super cropping of the Cannabis it triples or even quadruples the colas per branch. Our invention permits a user to take advantage of the most favorable growth patterns of all species of plant including Cannabis which is not possible with current devices available.

Despite the existing support apparatuses and the use of the foregoing growing techniques, there exists a need for an improved apparatus for supporting a plant as it grows that would permit a user to controllably stress the plant to optimize its growth. The improved plant support and training apparatus should be configured to spread out the plant's limbs and branches to improve airflow and light to the interior of the plant and to support those parts of the plants, including branches and limbs, that are likely to break or otherwise be damaged by the weight of the plant part or the produce growing from the plant part. Preferably, the improved plant support and training apparatus should limit the number of stakes that are driven into the soil around the stem of the plant to reduce the likelihood of damaging the plant's root system. The improved plant support and training apparatus should also be configured to allow the user to be able to train the plant to grow in the manner that he or she desires to improve the growth and production of the plant. The improved plant support and training apparatus should also be configured to be beneficially utilized with plants grown in pots by allowing the user to still be able to move, rotate or otherwise change the location of the plant pot. Preferably, the improved plant support and training apparatus will be adaptable to a wide range of plants and be able to be inexpensively manufactured.

The subject matter discussed in this background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represent different approaches, which in and of themselves may also be inventions.

### DISCLOSURE OF THE INVENTION

The apparatus and system for supporting and training plants of the present invention solves the problems and provides the benefits identified above. That is to say, the present patent application discloses a plant support and training apparatus which is structured and arranged to overcome the natural growing pattern of the plant to increase the amount of air and light received by the interior of the plant and to support the plant as it grows in soil or other growing mediums. More specifically, the plant support and training apparatus of the present invention is structured and arranged to beneficially spread out the limbs and branches of a plant to allow more air and light to reach the interior portion of the plant and to support its branches and limbs that are likely to break or otherwise be damaged by the weight of the plant part itself or the produce that is growing from the plant part. Use of the plant support and training apparatus of the present invention substantially reduces the number of stakes that are required to be driven into the soil around the stem of the plant, which significantly reduces the likelihood that the plant's root system will be damaged by the new plant support and training apparatus. The new plant support and training apparatus facilitates the user being able to train the plant so the plant will grow in the manner desired.

In one use of the new plant support and training apparatus the user can direct the branches and limbs so they are generally spread apart to increase the amount of light and air into the central part of the plant and facilitate inspection and, as needed, treatment of the plant. The plant support and training apparatus of the present invention can be beneficially utilized with plants grown in pots to allow the user to be able to move, rotate or otherwise change the location of the plant pot while the plant is still growing in the pot. In preferred configurations, the plant support and training apparatus of the present invention is adaptable to a wide range of plants and is able to be inexpensively manufactured.

In one aspect of the present invention, the plant support and training apparatus is configured to support and train one or more branches of a plant that is growing in soil so as to establish a circular growing pattern for the plant that will provide more air and light for the center area of the plant. In one embodiment, the apparatus has an elongated post, one or more support arms and a coiled member associated with at least one of the support arms. The post has a post body having a lower end and an upper end, with the lower end of the post body being adapted to be placed on or in the soil. Each of the support arms has an elongated arm body with a first end and a second end, with the arm body being attached to or integral with the upper end of the post body. The coiled member has a coiled-shaped body with a first end, a second end and a plurality of coils. The first end of the coiled-shaped body is attached to or integral with the first end of the arm body and the second end of the coiled-shaped body is attached to or integral with the second end of the arm body. The coils define a plurality of gaps or interstitial spaces, with each being sized and configured to receive and support at least one of the branches of the plant to define the desired circular growing pattern thereof. In one embodiment, the support arm has a generally u-shaped arm body and the coiled member is positioned in spaced apart relation to a top side of the arm body. In another embodiment, the apparatus has an attachment mechanism that movably attaches the support arm to the upper end of the post to allow the support arm to move relative to the upper end of the post. In yet another embodiment, the apparatus has a connecting mechanism that is associated with each of the first end of the coiled-shaped body and the first end of the arm body and with each of the second end of the coiled-shaped body and the second end of the arm body. The connecting mechanism can be a pin at each of the first end and the second end of the coiled-shaped body and an aperture at each of the first end and the second end of the arm body, with the pin and the aperture being cooperatively configured to secure the coiled-shaped body to the arm body. If desired, at least one of the support arms can include a pivot device that allows one portion of the support arm to pivot relative to another portion of the support arm for plants at or near the outer footprint of the light from the light source. In one configuration, the apparatus has a first support arm, a second support arm and a third support arm, with each of the first support arm and the third support arm having a coiled member.

Accordingly, the primary object of the present invention is to provide an apparatus for supporting and training plants that has the various advantages set forth above and elsewhere in the present disclosure and which overcomes the disadvantages and limitations associated with presently available apparatuses for supporting a plant while it grows and is harvested. It is also an important objective of the present invention to provide a plant support and training apparatus that helps the user to overcome the natural growth patterns of a plant to increase the amount of air and light that reach the interior of the plant and to support the limbs and branches of the plant as it grows.

An important aspect of the present invention is that it provides a new plant support and training apparatus that achieves the various objectives set forth above and elsewhere in the present disclosure. It is an important aspect of the present invention to provide a plant support and training apparatus that is structured and arranged to allow the user to be able to better train the plant to grow in the manner desired by a user.

It is an important aspect of the present invention to provide a plant support and training apparatus that is structured and arranged to spread out the limbs and branches of the plant to increase the amount of air and light which reach the interior of the plant to improve plant growth and production and to facilitate treating the plant.

It is also an important aspect of the present invention to provide a plant support and training apparatus that is structured and arranged to support a plant in a manner that supports those parts of a plant, including its branches and limbs, that are likely to break or otherwise be damaged by the weight of the plant part itself or by the produce that is growing from the plant part.

It is also an important aspect of the present invention to provide an improved plant support and training apparatus that substantially reduces the number of stakes that are required to be driven into the soil around the stem of the plant to reduce the likelihood that the plant's root system will be damaged.

It is also an important aspect of the present invention to provide an improved plant support and training apparatus that can be easily and beneficially utilized with plants which are being grown in pots in order to allow the user to move, rotate or otherwise change the location of the plant pot, as may be desired or necessary to benefit the plant, while the plant is still growing in the pot or transplanted to another pot. The present invention facilitates the attachment and removal of user selected plant components by incorporation of a coiled spring or continuous looped member that can be stressed and relaxed to effectively hold and/or release the plant by the stored energy exerted on the interstitial spaces between the coils or loops. An abrasive surface on the device permits a user to controllably abrade or stress the plant components and more effectively holding the plant component in place minimizing the plant component from sliding to a less desirable position.

In the most preferred embodiment of the present invention interchangeable coiled springs are utilized. The springs are magnetized and have disposed on the surface of the spring a ceramic and polymer coating with a low coefficient of thermal conductivity to minimize transfer of heat from a light source and the plant. Interspersed in the coating are granules of an abrasive substance such as sand, stone or other mineral sized as selected by user to abrade and stress particular plants or the same plant at various stages of its growth. Larger plants with heartier stems placed in the device would be more effectively abraded or stressed with a larger granule, whereas a younger plant or one that has a more delicate stem would require a much finer granule like that of sand. In this embodiment the spring is elongated increasing the interstitial spaces formed by the spring by a dial that may be operated manually or with its attached motor. Once the spring is elongated the user then places user selected stems in selected interstitial spaces so as to optimize air flow and light exposure to the plant. The abrasive surface will serve to both abrade the plant thereby stressing it and prevent the plant from sliding out of the interstitial space while other stems are being placed. Once all the plant stems are placed the dial is turned (manually or by motor) to release the tension on the spring caused by its elongation thereby pinching in place the plant stems. The spring is also attached to a motor that can turn the spring about the axis of the coil of the spring and provide a vibration through the spring. Light, temperature and humidity sensors are attached to the spring's support structure such that they are in close proximity to the plant and able to detect the environment in close proximity to the plant. The motor, the spring's elongation dial and the light, temperature and humidity sensors are all in electronic communication with a cellular microcontroller. The cellular microcontroller is programmed to activate the motor to turn the spring a desired rotation thereby placing a desired level of stress on the plant and then reverse the rotation of the spring to release the stress, or if desired stress the plant by an opposite rotation. The cellular microcontroller can also be programmed to activate the motor on the dial to elongate the spring thereby reducing the grip of the spring and also activate the motor to rotate the spring and change the contact point of the plant in the spring and further abrade or stress the plant and once complete the elongation of the spring is released thereby gripping the plant in another part of the stem, either closer to the main stem of the plant or further away according to the user's desired location. In addition to the data the cellular microcontroller receives from the motor, the spring elongation dial and the light, temperature and humidity sensors it also receives data from and communicates with the user selected light source and environmental controls. The cellular microcontroller may be programmed to change the lumens emanating from the light source and control the temperature and humidity of the environmental controls to optimize growing conditions for the plant based upon the devices sensor readings. The cellular microcontroller is connected by means of the Internet through the cloud to user selected devices such as a cell phone or personal computer or mainframe computer. A user may remotely program the cellular microcontroller and/or control any of the devices connected to it such as the motor, the elongating dial, the light source or the environmental controls.

Another important aspect of the present invention is to provide an improved plant support and training apparatus that is adaptable to a wide range of different types of plants and plant pots. Yet another important aspect of the present invention is to provide an improved plant support and training apparatus that is generally inexpensive to manufacture and easy to use.

As will be explained in greater detail by reference to the attached figures and the description of the preferred embodiment which follows, the above and other objects and aspects are accomplished or provided by the present invention. As set forth herein and will be readily appreciated by those skilled in the art, the present invention resides in the novel features of form, construction, mode of operation and combination of processes presently described and understood by the claims.

The description of the invention which follows is presented for purposes of illustrating one or more of the preferred embodiments of the present invention and is not intended to be exhaustive or limiting of the invention. The scope of the invention is only limited by the claims which follow after the description.

### BRIEF DESCRIPTION OF THE DRAWINGS

The accompanying drawings, which are incorporated herein and constitute part of this specification, depict example embodiments of the disclosure, and together with the general description given above and the detailed description given below, serve to explain the features of the various embodiments.

FIG. 1 depicts a flow chart showing a method of use of a Plant Support and Growth Directing Apparatus according to all the disclosed embodiments.

FIG. 2 depicts a side view of a non-adjustable tensile resistance coiled spring plant member retaining embodiment of a Plant Support and Growth Directing Apparatus.

FIG. 3 is a cutaway side view of the abrasive material coated coiled spring that comprises an elastic object capable of storing mechanical energy component of the Plant Support and Growth Directing Apparatus depicted in FIG. 2.

FIG. 4 depicts a side view of an adjustable tensile resistance coiled spring plant member retaining embodiment of the Plant Support and Growth Directing Apparatus depicted in FIG. 2 with a plant operatively attached to the apparatus with one branch of which has been supercropped.

FIG. 5 depicts a side view of an adjustable tensile resistance coiled spring plant member retaining embodiment of the Plant Support and Growth Directing Apparatus depicted in FIG. 2 with a plant that has been harvested and remains attached to the apparatus while inverted for drying or other user desired processing of the plant.

FIG. 6 is a cutaway side view of the adjustable tensile resistance coiled spring plant member retaining embodiment of a Plant Support and Growth Directing Apparatus with a coiled spring variable resistance adjustment knob shown in the released position thereby retaining a user selected portion of a plant by the coiled spring's tensile mechanical energy within the interstitial spaces between the coils of the coiled spring.

FIG. 7 is a further cutaway side view of the adjustable tensile resistance coiled spring plant member retaining embodiment of the Plant Support and Growth Directing Apparatus depicted in FIG. 6 shown in the released position thereby retaining a user selected portion of a plant by the coiled spring's tensile mechanical energy within the interstitial spaces between the coils of the coiled spring.

FIG. 8 is a cutaway side view of the adjustable tensile resistance coiled spring plant member retaining embodiment of the Plant Support and Growth Directing Apparatus depicted in FIG. 6 with a coiled spring variable resistance adjustment knob shown in the fully engaged position thereby opening the interstitial spaces between the loops thereby permitting a user selected portion of a plant to either be placed or removed from the interstitial spaces between the coils of the coiled spring.

FIG. 9 is a further cutaway side view of the adjustable tensile resistance coiled spring plant member retaining embodiment of the Plant Support and Growth Directing Apparatus depicted in FIG. 6 with a coiled spring shown in the fully engaged position thereby opening the interstitial spaces between the loops thereby permitting a user selected portion of a plant to either be placed or removed from the interstitial spaces between the coils of the coiled spring.

FIG. 10 depicts a side view of the most preferred embodiment of a Plant Support and Growth Directing Apparatus with a plant being aligned for placement in the device with the additional elements of: an attached motor capable of rotating the coiled spring; a tension dial that operates manually or by motor; a thermal protective coating disposed on the spring; the spring being magnetized; an abrasive material disposed on the spring; light, temperature and humidity sensors; and a cellular microcontroller in electronic communication therewith.

FIG. 11 depicts a cutaway portion of the spring with a plant being aligned for placement in the device as depicted in FIG. 10 with the thermal protective coating and abrasive material labeled thereon.

FIG. 12 depicts the Plant Support and Growth Directing Apparatus depicted in FIG. 10 with a plant held in place by the tension of the spring.

FIG. 13 depicts a cutaway portion of the spring depicted in FIG. 12 with the thermal protective coating and abrasive material labeled thereon.

FIG. 14 depicts the Plant Support and Growth Directing Apparatus depicted in FIG. 10 with a light source and environmental controls that are in electronic communication with a user of the apparatus.

### DETAILED DESCRIPTION

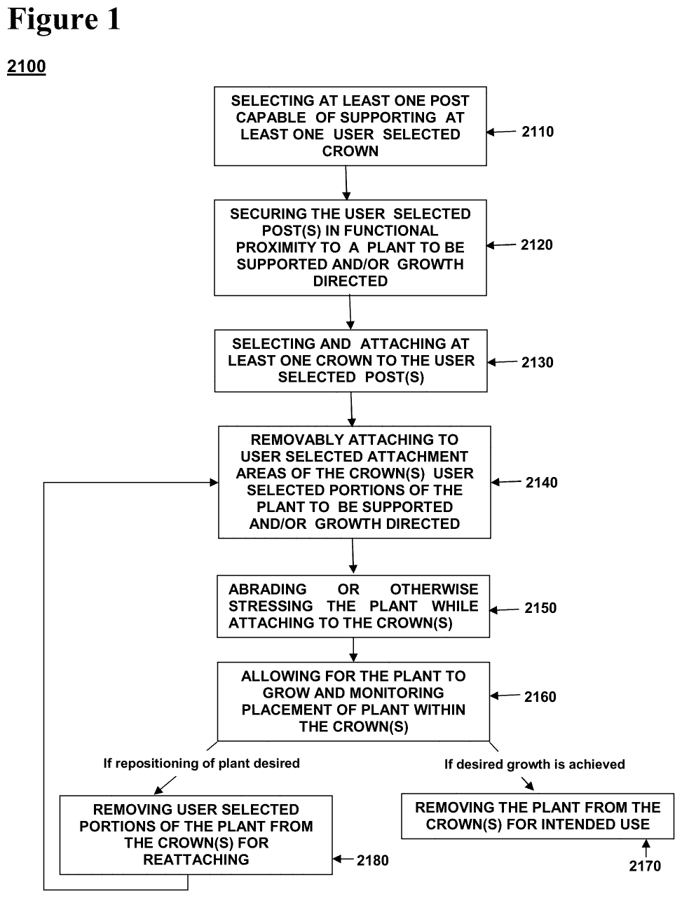

FIG. 1 depicts a flow chart showing a method of use of a Plant Support and Growth Directing Apparatus according to all the disclosed embodiments.

Referring to FIG. 1, a method of use 2100 may include the steps of: Selecting At Least One Post Capable Of Supporting At Least One User Selected Crown 2110; then Securing The User Selected Post(s) In Functional Proximity To A Plant To Be Supported And/Or Growth Directed 2120; then Selecting And Attaching At Least One Crown To The User Selected Post(s) 2130; then Removably Attaching To User Selected Attachment Areas Of The Crown(s) User Selected Portions Of The Plant To Be Supported And/Or Growth Directed 2140; then Abrading Or Otherwise Stressing The Plant While Attaching To The Crown(s) 2150; then Allowing For The Plant To Grow And Monitoring Placement Of Plant Within The Crown(s) 2160; then if desired growth is achieved then Removing The Plant From The Crown(s) For Intended Use 2170; or if repositioning of the plant is desired then Removing User Selected Portions Of The Plant From The Crown(s) For Reattaching 2180 and thereafter repeating steps 2140, 2150 and 2160 until the desired growth is achieved then 2170.

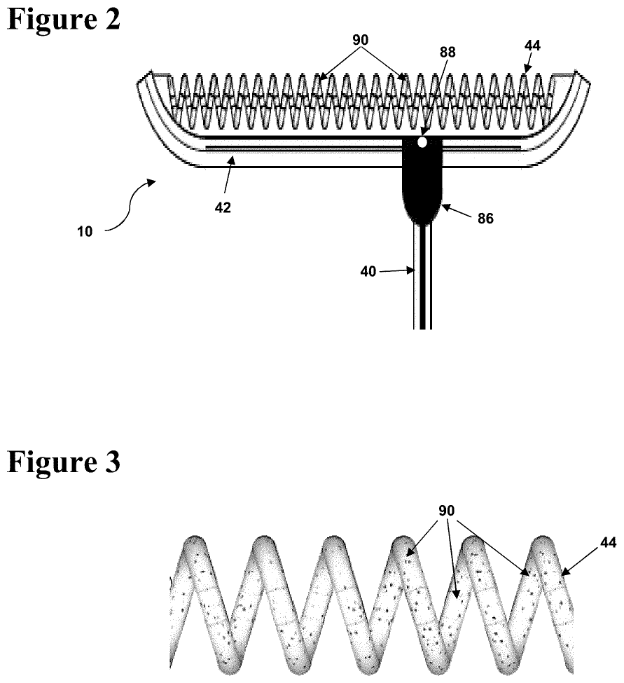

FIG. 2 depicts a side view of a non-adjustable tensile resistance coiled spring plant member retaining embodiment of a Plant Support and Growth Directing Apparatus.

FIG. 3 is a cutaway side view of the abrasive material coated coiled spring that comprises an elastic object capable of storing mechanical energy component of the Plant Support and Growth Directing Apparatus depicted in FIG. 2.

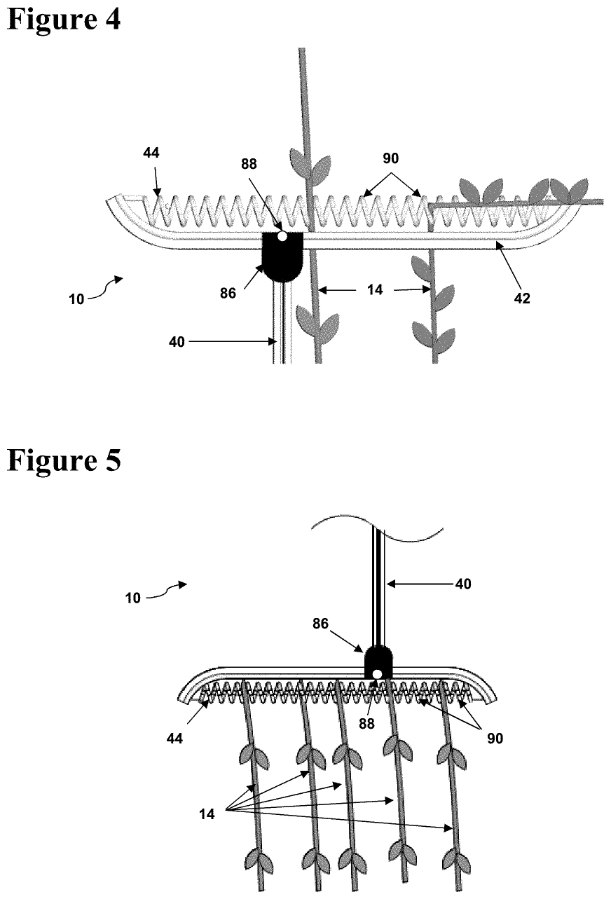

FIG. 4 depicts a side view of an adjustable tensile resistance coiled spring plant member retaining embodiment of the Plant Support and Growth Directing Apparatus depicted in FIG. 2 with a plant operatively attached to the apparatus with one branch of which has been supercropped.

FIG. 5 depicts a side view of an adjustable tensile resistance coiled spring plant member retaining embodiment of the Plant Support and Growth Directing Apparatus depicted in FIG. 2 with a plant that has been harvested and remains attached to the apparatus while inverted for drying or other user desired processing of the plant.

Referring to FIGS. 2,3,4 & 5 a Tensile Resistance Plant Member Retaining Embodiment 10 of the Plant Support and Growth Directing Apparatus of the present invention is shown. In this embodiment, the Tensile Resistance Plant Member Retaining Embodiment Crown 10 comprises an elongated Post 40 having an elongated Support Arm 42 attached to or integral with and extending outwardly from the Post 40, with the Support Arm 42 being structured and arranged to receive and support one or more Apical Branches 1602 of the Plant 14. In this embodiment, the Support Arm 42 comprises an Elastic Object Capable Of Storing Mechanical Energy 44, which can be a coiled spring or spring-like member. The Elastic Object Capable Of Storing Mechanical Energy 44 may also be any configuration of user selected successive components of varying shapes and sizes, such as triangular or polygonal, capable of storing mechanical energy. Disposed on the surface of the Elastic Object Capable Of Storing Mechanical Energy 44 is an Abrasive Surface 90 thereby more effectively holding a portion of a Plant 14 in a user desired position when placed there by a user. Also the Abrasive Surface 90 permits a user to controllably abrade the Plant 14 thereby stressing the Plant 14 to stimulate a desired growth response. The Abrasive Surface 90 being comprised of granules of abrasive material such as sand, stones or minerals of which size a user selects according to optimal use with the particular species of Plant 14 to effectively abrade and stress the Plant 14.

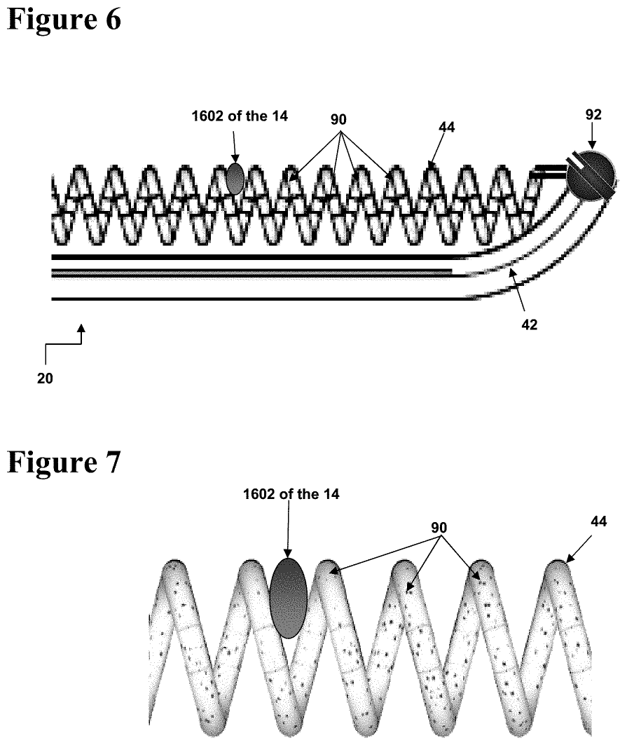

FIG. 6 is a cutaway side view of the adjustable tensile resistance coiled spring plant member retaining embodiment of a Plant Support and Growth Directing Apparatus with a coiled spring variable resistance adjustment knob shown in the released position thereby retaining a user selected portion of a plant by the coiled spring's tensile mechanical energy within the interstitial spaces between the coils of the coiled spring.

FIG. 7 is a further cutaway side view of the adjustable tensile resistance coiled spring plant member retaining embodiment of the Plant Support and Growth Directing Apparatus depicted in FIG. 6 shown in the released position thereby retaining a user selected portion of a plant by the coiled spring's tensile mechanical energy within the interstitial spaces between the coils of the coiled spring.

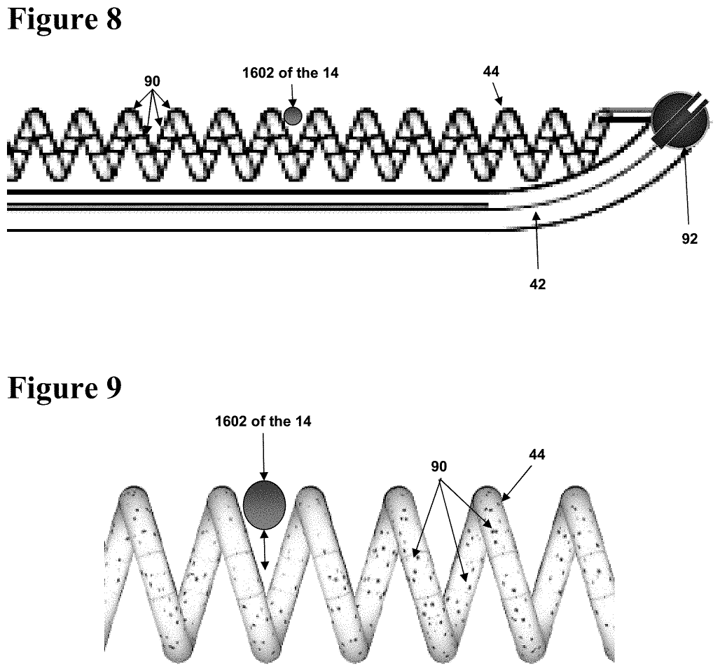

FIG. 8 is a cutaway side view of the adjustable tensile resistance coiled spring plant member retaining embodiment of the Plant Support and Growth Directing Apparatus depicted in FIG. 6 with a coiled spring variable resistance adjustment knob shown in the fully engaged position thereby opening the interstitial spaces between the loops thereby permitting a user selected portion of a plant to either be placed or removed from the interstitial spaces between the coils of the coiled spring.

FIG. 9 is a further cutaway side view of the adjustable tensile resistance coiled spring plant member retaining embodiment of the Plant Support and Growth Directing Apparatus depicted in FIG. 6 with a coiled spring shown in the fully engaged position thereby opening the interstitial spaces between the loops thereby permitting a user selected portion of a plant to either be placed or removed from the interstitial spaces between the coils of the coiled spring.

Referring to FIGS. 6,7,8 & 9 they depict the Tensile Resistance Plant Member Retaining Embodiment Crown 20. FIGS. 6 & 8 depict a Tension Dial 92 operatively attached to Elastic Object Capable Of Storing Mechanical Energy 44 which permits a user to place and hold tension on the Elastic Object Capable Of Storing Mechanical Energy 44 thereby expanding the size of the interstitial space between the individual coils or loops of the Elastic Object Capable Of Storing Mechanical Energy 44. A user then places the desired portions of the Plant 14 or Apical Branches 1602 within user selected expanded interstitial spaces. Once the Plant 14 or Apical Branches 1602 are in the desired location the user then adjusts the Tension Dial 92 in the opposite direction thereby releasing the user applied tension to the Elastic Object Capable Of Storing Mechanical Energy 44 thereby contracting the interstitial spaces thereby holding the Plant 14 or Apical Branches 1602 in the user desired position(s). In the absence of the Tension Dial 92, such as depicted in FIGS. 2,3,4 & 5, a user may manually place and release tension on the Elastic Object Capable Of Storing Mechanical Energy 44 with user selected tool such as a screwdriver or other rigid object. The Tension Dial 92 can be an adjustment knob, dial, lever or similar mechanism. Disposed on the surface of the Elastic Object Capable Of Storing Mechanical Energy 44 is an Abrasive Surface 90 thereby more effectively holding a portion of a Plant 14 in a user desired position when placed there by a user. Also the Abrasive Surface 90 permits a user to controllably abrade the Plant 14 thereby stressing the Plant 14 to stimulate a desired growth response. The Abrasive Surface 90 being comprised of granules of abrasive material such as sand, stones or minerals of which size a user selects according to optimal use with the particular species of Plant 14 to effectively abrade and stress the Plant 14.

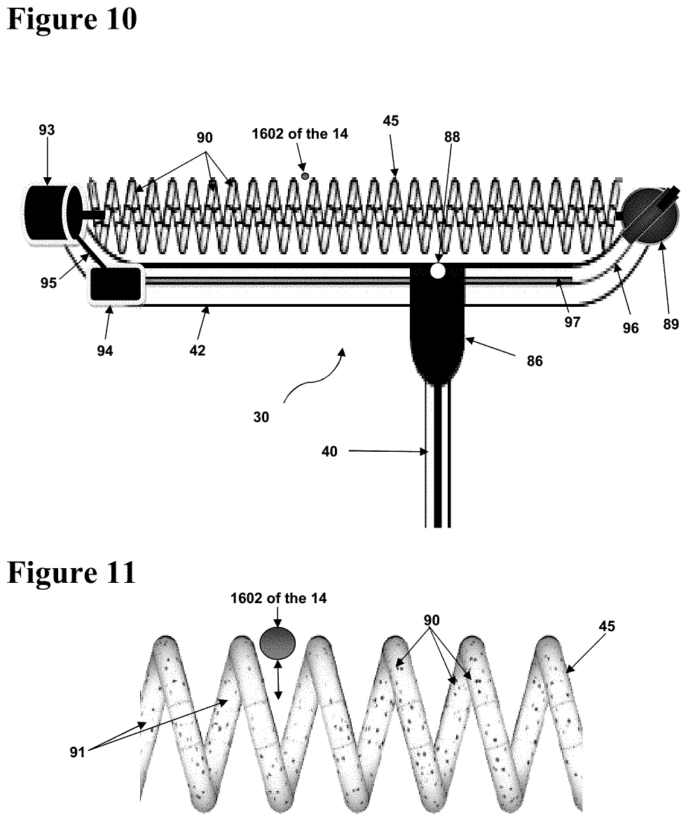

FIG. 10 depicts a side view of the most preferred embodiment of a Plant Support and Growth Directing Apparatus with a plant being aligned for placement in the device with the additional elements of: an attached motor capable of rotating the coiled spring; a tension dial that operates manually or by motor; a thermal protective coating disposed on the spring; the spring being magnetized; an abrasive material disposed on the spring; light, temperature and humidity sensors; and a cellular microcontroller in electronic communication therewith.

FIG. 11 depicts a cutaway portion of the spring with a plant being aligned for placement in the device as depicted in FIG. 10 with the thermal protective coating and abrasive material labeled thereon.

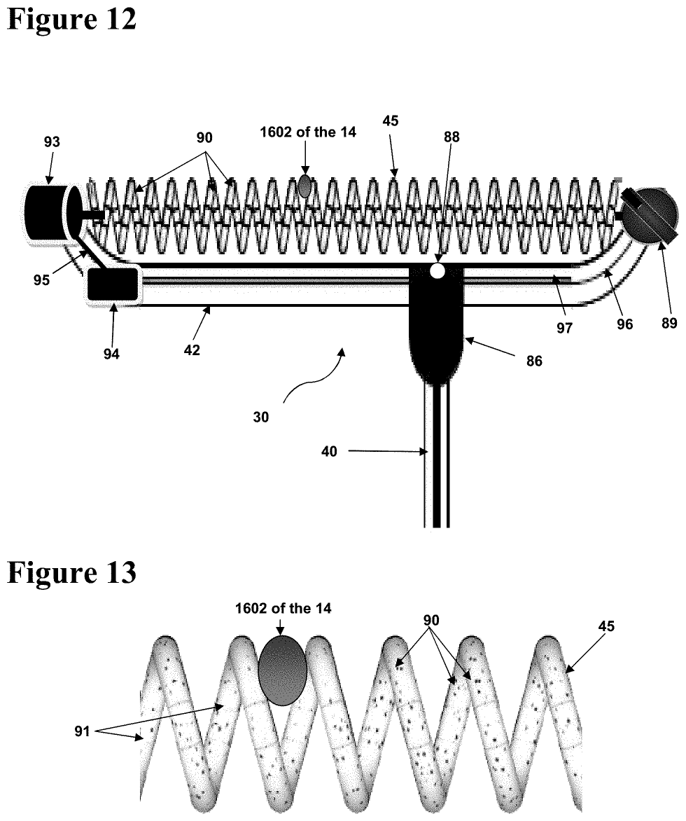

FIG. 12 depicts the Plant Support and Growth Directing Apparatus depicted in FIG. 10 with a plant held in place by the tension of the spring.

FIG. 13 depicts a cutaway portion of the spring depicted in FIG. 12 with the thermal protective coating and abrasive material labeled thereon.

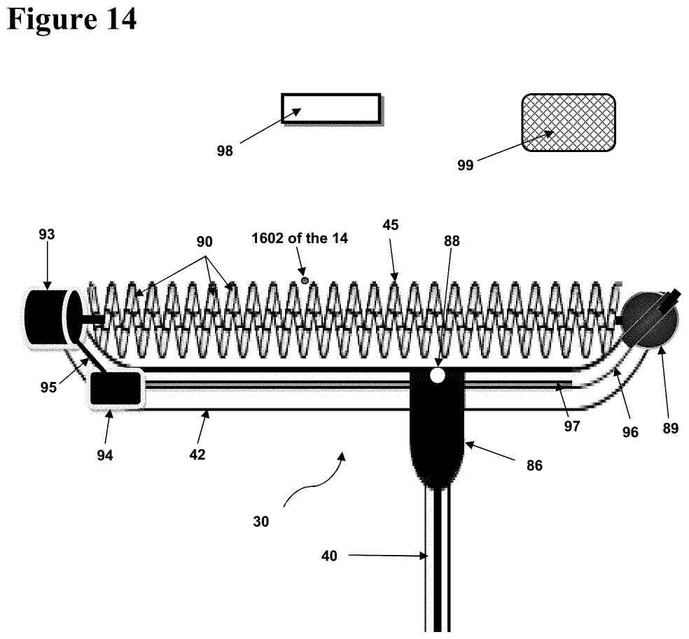

FIG. 14 depicts the Plant Support and Growth Directing Apparatus depicted in FIG. 10 with a light source and environmental controls that are in electronic communication with a user of the apparatus.

Referring to FIGS. 10,11,12,13 & 14 they depict the Electronically Monitored and Controlled Resistance Plant Member Retaining Embodiment Crown 30. Utilizing IoT (Internet of Things) technology the Electronically Monitored and Controlled Resistance Plant Member Retaining Embodiment Crown 30 utilizes a Cellular Microcontroller 94. The Cellular Microcontroller 94 may be powered by its own battery power source or receive external power from another user selected source that is independent or shared with the other components of the device. The Cellular Microcontroller 94 is in electronic communication with the Spring Turning Motor 93 by means of the Turning Motor Cable 95, the Dual Action Tensioning Knob 89 by means of the Tensioning Knob Cable 96, the Sensor Panel 97, at least one Light Source 98, and at least one Environmental Control 99.

Referring to FIGS. 10,11,12,13 & 14 the Electronically Monitored and Controlled Resistance Plant Member Retaining Embodiment Crown 30 is further comprised of a Magnetized Spring 45 which by virtue of its generation of a magnetic field will serve to stimulate the growth of a plant within its proximity. The Magnetized Spring 45 of FIGS. 10,11,12,13 & 14 serves to hold a Plant 14 or Apical Branches 1602 in the user desired location in the manner as depicted in FIGS. 2-6. The Magnetized Spring 45 of FIGS. 10,11,12,13 & 14 is thermally insulated from its contact with the Plant 14 or Apical Branches 1602 by means of a Thermal Insulator Coating 91 such as a ceramic-polymer. Light can cause the Magnetized Spring 45 to absorb heat and by contact transmit that heat to the Plant 14 or Apical Branches 1602 which may ultimately damage or even kill the Plant 14 or Apical Branches 1602. The Thermal Insulator Coating 91 reduces, if not eliminates such a transfer of heat to the Plant 14 or Apical Branches 1602. The Magnetized Spring 45 of FIGS. 10,11,12,13 & 14 is engineered to be removable from the device to replace it with another Magnetized Spring 45 with user selected abrasive properties. Disposed on the surface of the Magnetized Spring 45 is an Abrasive Surface 90 thereby more effectively holding a portion of a Plant 14 or Apical Branches 1602 in a user desired position when placed there by a user. Also the Abrasive Surface 90 permits a user to controllably abrade the Plant 14 thereby stressing the Plant 14 to stimulate a desired growth response. The Abrasive Surface 90 being comprised of granules of abrasive material such as sand, stones or minerals of which size a user selects according to optimal use with the particular species of Plant 14 to effectively abrade and stress the Plant 14.

FIGS. 10,12 & 14 depict a Dual Action Tensioning Knob 89 operatively attached to the Magnetized Spring 45. The Dual Action Tensioning Knob 89 either manually or by means of a motor controlled by the Cellular Microcontroller 94 communicating through the Tensioning Knob Cable 96 can elongate and relax the tension on the Magnetized Spring 45, thereby expanding or contracting the size of the interstitial space between the individual coils or loops of the Magnetized Spring 45. A user then places the desired portions of the Plant 14 or Apical Branches 1602 within user selected expanded interstitial spaces. Once the Plant 14 or Apical Branches 1602 are in the desired location the user then adjusts the Dual Action Tensioning Knob 89 either manually or by means of the Cellular Microcontroller 94 in the opposite direction thereby releasing the user applied tension to the Magnetized Spring 45 thereby contracting the interstitial spaces thereby holding the Plant 14 or Apical Branches 1602 in the user desired position(s). The Dual Action Tensioning Knob 89 is also capable of causing a vibration through the Magnetized Spring 45, which vibration intensity and duration is controlled by the Cellular Microcontroller 94 according to user programmed parameters. The vibration in the Magnetized Spring 45 is transmitted to the Plant 14 or Apical Branches 1602 that is held in the device by spring tension thereby producing a growth response in the Plant 14 or Apical Branches 1602 enhancing its growth thereby. This vibration is considered to be a form of stress to the plant.

As depicted in FIGS. 10,12 & 14 the Cellular Microcontroller 94 is in electronic communication with the Spring Turning Motor 93 by means of the Turning Motor Cable 95. Once the Plant 14 or Apical Branches 1602 is held in place by the Magnetized Spring 45 the Cellular Microcontroller 94 according to user programmed parameters then turns the Magnetized Spring 45 about the axis formed by the coils of the Magnetized Spring 45 such that as it turns it further stresses the Plant 14 or Apical Branches 1602 by pulling or pushing on the Plant 14 or Apical Branches 1602 depending upon the direction of rotation of the Spring Turning Motor 93, which turning may further stress the plant by abrading it further thereby stimulating a growth response by the Plant 14 or Apical Branches 1602. The Cellular Microcontroller 94 may also be programmed to have the tension on the Plant 14 or Apical Branches 1602 exerted by the Magnetized Spring 45 to hold it in place to be released or otherwise reduced by the Dual Action Tensioning Knob 89 such that the Spring Turning Motor 93 may then be activated allowing it to reposition the Plant 14 or Apical Branches 1602 within the Magnetized Spring 45 and then once repositioned the program would cause the Dual Action Tensioning Knob 89 to reverse the process and allowing the Magnetized Spring 45 to abrade and grip the Plant 14 or Apical Branches 1602 in its new location on the Plant 14 or Apical Branches 1602.

By means of the Cellular Microcontroller 94 the device will monitor light, temperature and humidity in close proximity to the plant by means of the attached Sensor Panel 97. By means of the Internet through the cloud data with respect to the temperature, light intensity and humidity from the Sensor Panel 97 together with data relative to the position, activation history and status of the Dual Action Tensioning Knob 89 and the Spring Turning Motor 93 are transmitted to the user which may be received on a cellular device such as a cell phone or tablet or by means of a personal or main frame computer. Similarly as depicted in FIG. 14 the Light Source 98 and the Environmental Control 99 are in electronic communication with the user by means of the Internet through the cloud transmitting data and/or otherwise being controlled remotely by the user, which communication will allow the user to determine and adjust the intensity of the light reaching the Plant 14 or Apical Branches 1602 from the Light Source 98 and to determine and adjust the ambient temperature and humidity level by adjusting the Environmental Control 99 which may be a form of heat pump, air conditioner and/or heater, or some combination thereof. Additionally the Light Source 98 and the Environmental Control 99 may be placed in electronic communication with the Cellular Microcontroller 94 which in turn may be accessed by the user for direct control by the user. In this configuration the Cellular Microcontroller 94 may also be programmed to directly and automatically control the Light Source 98 and the Environmental Control 99 in response to the data that it receives in real time from the Sensor Panel 97 as well as the Dual Action Tensioning Knob 89 and the Spring Turning Motor 93. Automatic control by the Cellular Microcontroller 94 is optimal since a failure or other malfunction of the Light Source 98 and the Environmental Control 99 may occur at times when a user is not on site or otherwise monitoring the system, in which case it may correct the matter automatically or otherwise send out a signal or warning to the user of a system failure which may cause the Plant 14 to perish.

In all three embodiments depicted in the drawings the Post Body 40 should be made from a material that is suitable for use around water, soil and whatever fertilizers or chemicals, if any, that will be utilized to help the Plant 14 grow, such as certain metals, plastic, fiberglass, composites, treated wood and the like. As will be readily appreciated by persons skilled in the art, virtually any material, including solid or hollow materials, can be utilized for the Post 40 as long as it is sufficiently stiff and strong enough to support the weight of the Support Arm 42 and Plant 14 or Apical Branches 1602 and plant product produced that will be supported by the device. Also an Attachment Mechanism 86 is utilized to moveably connect the Support Arm 42 to the Post 40. The Attachment Mechanism 86 shown are structured and arranged to slidably interconnect the Post 40 and Support Arm 42 so as to allow the user to position the Support Arm 42 where it will be most beneficial for the support and growth of the plant's Apical Branches 1602 and production of product from the Plant 14. To allow the user to move or fix the position of the Support Arm 42 relative to the Post 40, the Attachment Mechanism 86 can include one or more Connecting Elements 88, such as a screw, bolt or the like, that is loosened or removed to slide or otherwise move the Support Arm 42 relative to the Post 40 and then tightened or reattached to fix the position of the Support Arm 42 on the Post 40. As will be readily appreciated by persons skilled in the art, a variety of devices can be utilized as the Attachment Mechanism 86.

The component parts of the crowns of the above described embodiments may be comprised of a bendable material, such as metal, polymers, wood or the like, thereby permitting a user to make adjustments to the configuration of the apparatus while in use or preparing the apparatus for use.

Each of the posts of the above described embodiments may be comprised of two or more component parts or be telescopic thereby permitting a user to increase or decrease the length of the post such that a crown may be placed in a user desired position with respect to the plant.

According to the various embodiments of the Plant Support and Growth Directing Apparatus described herein may be utilized in conjunction with the plant cultivation techniques described above (e.g., topping, super cropping, and low stress training) to provide optimal light absorption to a supported plant. For example, a user may perform one or more of topping, super cropping, abrading and low stress training to induce lateral growth of a plant's canopy, and selectively weave the branches of the laterally growing canopy into the Plant Support and Growth Directing Apparatus according to various embodiments, as desired, to achieve optimal light absorption by the plant or other desired growth characteristics. In general each of the embodiments depicted above have a crown and a post and the crowns are each intended to be capable of being used in various combinations of the various crowns according to a user's desired use. A multiplicity of crowns may also be used and situated at different levels or planes at user desired distances which is accomplished with different lengths of posts which may be interconnected and lengthened or added to as a plant grows and additional support and direction is required by a user.

According to various embodiments, when the cannabis plant is in a “vegetation” cycle, half of the Post (e.g., in single Post designs) may be inserted into the soil, through the root mass, near the main stalk of the plant. This Post may be parallel to the plant's main stalk. Once the plant has reached a flowering stage, a second half of the Post may be connected to the lower half to form a solid pole that travels through the plant's canopy. This method may be accomplished in two parts to provide freedom to keep a light source at desired heights throughout the growing cycles. Once there is a small cluster of white pistils at the apical and auxiliary sites, about the width of a nickel, the Crown may be implemented. At this stage of growth the branches of the plant are strong and stiff, yet flexible and easily adjusted to bend without damage to the branches, and with the sites being small enough to maneuver through a rigid frame.

Various embodiments provide a modular support apparatus and method of manufacturing the same (e.g., for aiding in the growth of the Cannabis sativa and the Cannabis indica plants), which includes at least one vertical Post capable of supporting a modular collared platform that makes up the Crown of the structure and allows the branches of the plant to be woven through the structure. By weaving the branches through the Crown, the branches lay horizontally, exposing multiple (e.g., lower) sites to optimum light. Spiraling the branches around the Crown maximizes the space beneath the light's footprint, minimizing unused light. The Crown also provides support when plants (e.g., at the end of harvest) are laden with heavy flowers/fruits, as it is at this time that the flowers of the plant may become too heavy to bear its own weight. Furthermore, the plant may benefit from manipulations placed upon their branches, exposing a greater number of growth sites to needed optimum light spectrums. In addition, the Crown aids in the leveling of the growth canopy (e.g., for increasing light penetration), creating a low-stress super cropping effect on the supported plant, furthering development of the plant by opening up or broadening the canopy, and exposing lower growth sites of the plant to a light source (e.g., an overhead stationary light source).

In various embodiments, use of the Plant Support and Growth Directing Apparatus, which provides re-usable support along with the low stress super cropping effect to a supported plant, requires minimal labor. Each of the embodiments described herein, by having few components, may be implemented and assembled by a user quickly and easily without tools. When disassembled, some embodiments may be easily washed and dried by hanging the apparatus (e.g. the Facet) (e.g., on a wall or a similar vertical structure).

According to various embodiments, the Facets of the Plant Support and Growth Directing Apparatus may also provide spacing between branches. This is beneficial for providing air flow between the branches, as plants use carbon dioxide and sunlight to make their own food and to grow. As such, circulating fans may be present in grow rooms to ensure the movement of oxygen away from the plant, and to circulate carbon dioxide throughout the plant.

Because various embodiments are simple structures, they will be easily cleanable (e.g., in a dishwasher), for efficiently cleaning build-up of resins that plants naturally produce, certain foliage sprays, and potential molds and mildews (e.g., that may occur at the later stages of growth) that build up on the Plant Support and Growth Directing Apparatus. As such, sanitizing the Plant Support and Growth Directing Apparatus ensures a clean and safe support for future generations of the plants. On the other hand, other forms of support, such as netting can only be used once, and bamboo stakes only two to three times due to degradation. Furthermore, there are limitations of traditional staking devices (e.g., pole support techniques), such as the time it takes to wrap bands or tie up with twine when securing the branches to the Post or stake (e.g., there may be multiple connectors for each branch). Additionally, the wrapping or tying material used in these conventional techniques may rub against the developed flowers of the plant while being secured, resulting in damage to the plant. In addition, bamboo's hollow center may provides shelter for pests to hide in when a spray or fogger is used on the plant.

The above used terms, including “attached,” “connected,” “fastened,” “secured,” “coupled,” “integrated,” and the like are used interchangeably. In addition, while certain embodiments have been described to include a first element as being “coupled” (or “attached,” “connected,” “fastened,” etc.) to a second element, the first element may be directly coupled to the second element or may be indirectly coupled to the second element via a third element.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Any actual dimensions listed are those of the preferred embodiments. Actual dimensions or exact hardware details and means may vary in a final product or most preferred embodiments and should be considered means for so as not to narrow the claims of the patent. Thus, the previous description is not intended to be limited to the implementations shown herein but is to be accorded the widest scope consistent with the principles and novel features disclosed herein. Accordingly, the scope of the invention should be determined not by the embodiments illustrated, but by the claims and their legal equivalents which accompany this application.

Having described our invention, we claim:

1. A plant stressing, support and growth directing apparatus for supporting and training at least one branch of a plant comprised of:
at least one post;
at least one crown support means attached to the post;
at least one crown attached to the crown support means;
the crown being comprised of at least one elastic object capable of storing mechanical energy having at least one interstitial space;
the crown being further comprised of at least one plant stressing means; and
the crown being further comprised of at least one plant positioning means attached to the crown.

2. The plant stressing, support and growth directing apparatus of claim 1 wherein the elastic object capable of storing mechanical energy having at least one interstitial space is a coiled spring;
the coiled spring being coated with a thermal insulator.

3. The plant stressing, support and growth directing apparatus of claim 1 wherein the plant stressing means is comprised of the coiled spring with an attached abrasive surface.

4. The plant stressing, support and growth directing apparatus of claim 1 wherein the coiled spring is magnetic.

5. The plant stressing, support and growth directing apparatus of claim 1 wherein the plant stressing means is a motor capable of turning the elastic object capable of storing mechanical energy having at least one interstitial space about an axis.

6. The plant stressing, support and growth directing apparatus of claim 1 wherein the plant positioning means is at least one interstitial space of the elastic object capable of storing mechanical energy having at least one interstitial space comprising the component.

7. The plant stressing, support and growth directing apparatus of claim 1 wherein the elastic object capable of storing mechanical energy having at least one interstitial space is further comprised of a tension adjustment means capable of placing the elastic object capable of storing mechanical energy having at least one interstitial space under tension thereby increasing the size of the interstitial space and further being capable of releasing the tension thereby decreasing the size of the interstitial space.

8. The plant stressing, support and growth directing apparatus of claim 1 is further comprised of a cellular microcontroller in electronic communication with the elastic object capable of storing mechanical energy having at least one interstitial space, the plant stressing means and the plant positioning means.

9. The plant stressing, support and growth directing apparatus of claim 8 wherein the cellular microcontroller is wirelessly accessible and programmable.

10. The plant stressing, support and growth directing apparatus of claim 9 is further comprised of at least one light that is in electronic communication with the cellular microcontroller and capable of being controlled by the cellular microcontroller.

11. The plant stressing, support and growth directing apparatus of claim 9 is further comprised of at least one means of controlling ambient temperature and humidity that is in electronic communication with the cellular microcontroller and capable of being controlled by the cellular microcontroller.

12. The plant support and growth directing apparatus of claim 1 further comprising a crown attachment means for movably attaching the crown to the post, wherein the crown attachment means is structured and arranged to allow the crown to move relative to the post.

13. The plant support and growth directing apparatus of claim 1 wherein at least one component of the crown is further comprised of at least one pivotable portion.

14. The plant support and growth directing apparatus of claim 1 wherein the post is comprised of at least two parts capable of being assembled together or disassembled thereby permitting a user to assemble or disassemble the post to a user desired length.

15. The plant support and growth directing apparatus of claim 1 wherein the post is telescopic.

16. A method of using the plant support and growth directing apparatus of claim 1 consisting of the steps of:
selecting the post of a user desired length;
attaching the post to the user selected post support means;
selecting at least one crown of a user desired configuration;
attaching the crown to the post;
adjusting the crown to a user desired position;
positioning at least one user selected portion of the plant to the plant positioning means in a user defined configuration to support and direct the growth of the plant in a manner desired by the user;
stressing the user selected portion of the plant to stimulate a user desired response from the plant;
permitting the plant a user desired period of time to grow;
removing the user selected portion of the plant from the plant positioning means if a user desired growth has been achieved and/or the user desires to harvest the plant and if the user desired growth has not been achieved and repositioning is desired by the user then;
repositioning at least one user selected portion of the plant to the plant positioning means in a user defined configuration to support and direct the growth of the plant in a manner desired by the user; and/or
increasing the length of the post to form a lengthened post of a user desired length;
selecting at least one additional crown of a user desired configuration;
attaching the additional crown to the lengthened post;
adjusting the additional crown to a user desired position;
positioning at least one user selected portion of the plant to the plant positioning means of the additional crown in a user defined configuration to support and direct the growth of the plant in a manner desired by the user; and
repeating one or more of the steps of the method until the user desired growth has been achieved and/or the user desires to harvest the plant.
